(19) United States
(12) Patent Application Publication
(10) Pub. No.: US 2010/0178176 A1
(43) Pub. Date: Jul. 15, 2010

(54) Retractable Pump System

(76) Inventors: Jeremy Kenyon, Chico, CA (US); Brian Simpson, Chico, CA (US)

Correspondence Address: BULLIVANT HOUSER BAILEY PC, 1415 L STREET, SUITE 1000, SACRAMENTO, CA, 95814, US

(21) Appl. No.: 12/684,808

(22) Filed: Jan. 8, 2010

Related U.S. Application Data
(60) Provisional application No. 61/143,737, filed on Jan. 9, 2009.

(51) Int. Cl. B67D 7/58; A62C 25/00

(52) U.S. Cl. 417/53; 169/53

(57) ABSTRACT

A system and method for utilizing a retractable pumping system installed on an aerial fire fighting helicopter adapted for drawing from a body of water to fill an onboard holding tank. The system comprising: a pump; a collapsible conduit; a housing for holding the collapsible conduit in a retracted position; a conduit for directing fluid into the reservoir and means for securing the housing to a helicopter; where the conduit can be extended up to 15 feet.

### REFERENCE TO RELATED APPLICATION

This application claims the benefit of U.S. Provisional Patent Application No. 61/143,737, filed Jan. 9, 2009, the complete disclosure of which is incorporated herein, in the entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files and records, but otherwise reserves all other copyright rights.

### BACKGROUND OF THE INVENTION

1. Field of the Invention

This invention relates to aerial fire fighting helicopters used for fighting ground fires and more particularly, to a retractable snorkel for a pump system used to draw water into an onboard holding tank from a body of water such as a lake, river, reservoir, or the like.

2. Description of Related Art

In various adaptations of helicopters for aerial fire fighting, tanks of up to 2,000 gallons or more have been attached to the underside or mounted inside the helicopter. A fill tube or “snorkel” often extends from the tank and a submersible hydraulic or electric pump is attached at its the free end which can be lowered into a body of water for pumping water up the snorkel conduit and into the tank. The conduit is normally of a semi-rigid construction to help minimize movement and offer some stability.

The snorkel conduit often has a diameter of up to 10″and a length of up to 20 feet or more. The first section of the snorkel conduit allows the pump to clear the landing gear, while the remaining length provides clearance between the helicopter and body of water while hovering during fill operations.

The pump employed in these operations is typically a hydraulic or electrical pump capable of filling up to a 2,000 gallon tank in as little as one minute with up to a head height of 20 feet or more. The pumps vary in size and generally draw hydraulic or electrical power directly from the aircraft.

Limitations to the use of smaller helicopters for this purpose were addressed in U.S. Pat. No. 6,209,593, which discloses a pump system for a helicopter tanker that includes an axial flow electric pump coupled to the lower end of a conduit having a generally tubular pump housing extending along a central axis between an open upper end and an opposite open lower end serving as an inlet of the pump. In such a pumping system an electric axial flow pump is mounted to the free end of a snorkel extending from an onboard storage tank. The electric pump is one that is capable of delivering 1,000 gpm through a 6 inch diameter snorkel at a head of about 12 feet and operates at about 7.5 horsepower off a 10 kW or less on board generator. An electric axial flow pump weighs a fraction of the hydraulic centrifugal pump used in other adaptations. The lower horsepower requirements make the pump system suitable for use on smaller helicopters.

Larger military type helicopters, such as the Eurocopter EC-225 Super Puma and the Sikorsky UH-60 Black Hawk, have advantages for being adapted to fire fighting operations, notably the large carrying capacity means that more water can be conveyed in a given operation.

The snorkel, including the pump, semi-rigid conduit and electrical cable or hydraulic lines, on these systems, generally is not retractable and simply hangs from the helicopter during all modes of operation. Forward flight operations on aircraft utilizing a hanging snorkel system are often restricted to a lower maximum forward speeds due to unsafe characteristics of the snorkel during higher forward flight. The hanging type snorkel also provides a snagging hazard during normal operations.

Landing operations for aircraft utilizing a hanging type snorkel pumping system generally requires the operator to lay the snorkel pump and conduit horizontally on the ground prior to completing the landing sequence. Generally this is done by resting the pump on the ground and then moving forward or aft while reducing altitude above the ground until a full landing is completed.

Some aircraft with a hanging type snorkel with a semi rigid conduit have been modified with a winch type system that allows tethering of the pump toward the rear of the aircraft to help secure the pump and semi-rigid conduit.

None of the prior approaches have been able to provide such a system where a large volume has been able to be drawn from a great height and be fully retractable, allowing for normal operations.

### SUMMARY OF THE INVENTION

A system and method for utilizing a retractable pumping system installed on an aerial fire fighting helicopter for drawing from a body of liquid to fill an onboard reservoir, the system comprising: a pump; a collapsible conduit; a housing for holding the collapsible conduit in a retracted position; a conduit for directing pumped fluid into the reservoir and means for securing the housing to a helicopter; where the conduit can be extended up to approximately 15 feet.

In one embodiment of the invention the conduit extends up to approximately 18 feet.

In one embodiment of the invention the conduit extends up to approximately 21 feet.

In one embodiment of the invention the housing comprises a reel.

In one embodiment of the invention the reel is controlled mechanically.

In one embodiment of the invention the reel is controlled electronically.

In one embodiment of the invention the reel is equipped with guide flanges to allow proper spooling of the collapsible conduit.

In one embodiment of the invention there is a bumper to allow for proper seating of the pump into the retractable pumping system during retraction.

In one embodiment of the invention there is a spring loaded guide which allows for proper securing of the pump after retraction.

In one embodiment of the invention there is an electrical interface to the helicopter to allow for controlling of the retractable pumping system.

In one embodiment of the invention there is an electrical interface to the helicopter for supplying power to the retractable pumping system.

In another embodiment of the invention, there is provided a method of filling an onboard holding tank of a helicopter tanker with fluid, deploying a retractable pumping system for an aerial fire fighting helicopter adapted for drawing from a body of fluid to fill an onboard holding tank of the helicopter, the system comprising: a pump; a collapsible conduit; a housing for holding the collapsible conduit in a retracted position; a conduit for directing fluid into the holding tank; and means for securing the housing to a helicopter; where the conduit can be extended up to approximately 15 feet.

In one embodiment of the invention, there is included a step for filling an onboard reservoir with up to, but not limited to, 1000 gallons of fluid.

In one embodiment of the invention the onboard reservoir is carried within a Eurocopter EC 225 Super Puma.

In one embodiment of the invention the onboard reservoir is mounted on a Sikorsky UH-60 Black Hawk.

These and other features and advantages of this invention are described in, or are apparent from, the following detailed description of various exemplary embodiments of the apparatus and methods according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 shows a perspective view of the retractable pump system attached to a helicopter body.

FIG. 2 is an alternative view of the retractable pump system shown in FIG. 1.

FIG. 3 shows the pump with the hose retracted.

FIG. 4 is an alternative view of the retractable pump system shown in FIG. 3.

FIG. 5 is a perspective view showing a retractable pump system detached from the helicopter.

FIG. 6 is an alternative view of the pump unit shown in FIG. 5.

FIG. 7 is a perspective view showing a pump unit with the case withdrawn to show the internal hose reel operation.

FIG. 8 is an alternative view of the pump unit shown in FIG. 7.

### DETAILED DESCRIPTION OF THE INVENTION

The products and methods of the present invention provide a retractable system capable of being applied to various helicopters requiring greater safety during fire fighting operations, multi-role capabilities and fewer flight restrictions.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

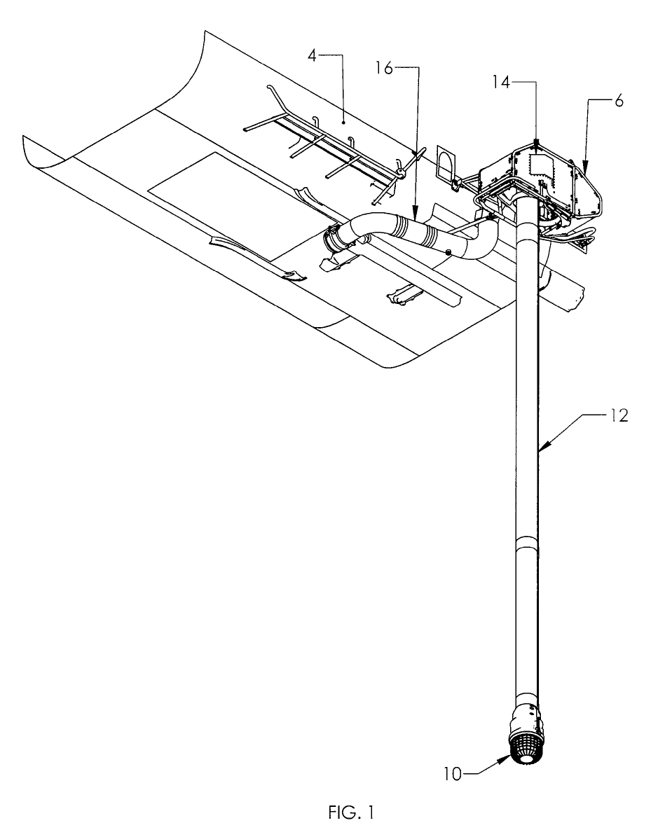

As will be apparent from the drawings, the adaptation to fire fighting of a large helicopter such as the EC 225 Super Puma is easily accomplished using the present retractable snorkel system. As shown in FIG. 1, a helicopter fuselage 4 is depicted with the retractable pump system 6 attached.

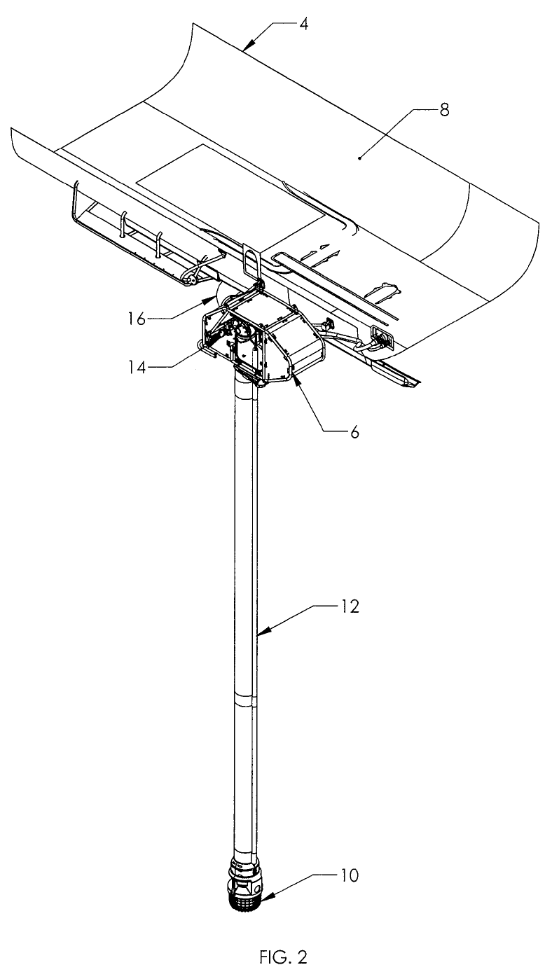

As shown in FIG. 2, internal to the helicopter fuselage 4 is a reservoir 8 for storing dispersal materials.

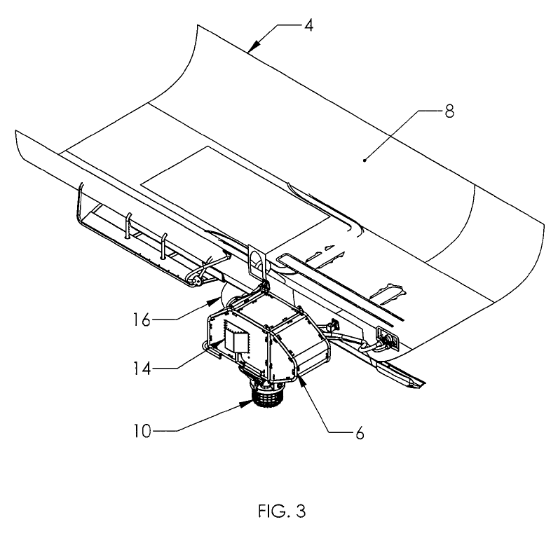

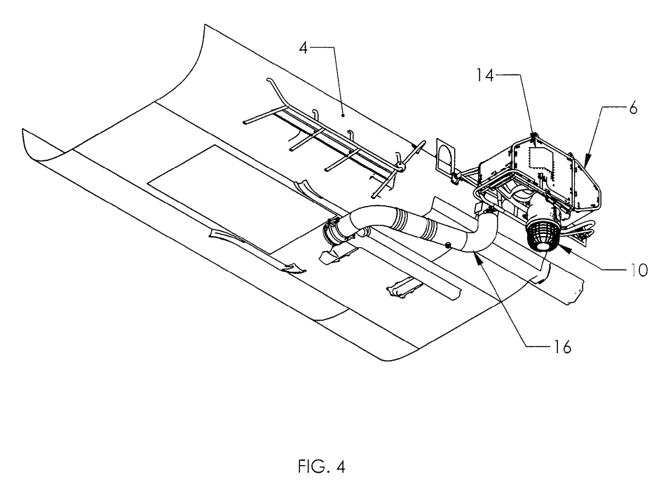

In reference now to FIGS. 1, 2, 3 and 4, the system 6 includes a pump 10 attached to the end of a retractable hose or snorkel 12, which is shown as extended in FIGS. 1 and 2, and as collapsed in FIGS. 3 and 4. The hose 12 is capable of extending up to 15 feet, or more. The main limitation in distance is to find that greatest length where under the conditions for type of helicopter and weather, the stability of both the helicopter 4 and the pumping operation during filling of the reservoir 8 can be maintained for a sufficient time to fill the reservoir.

At an extended length of 15 feet, the pump 10 can pump 1000 gallons every 65 seconds. The pump may be extended even further, to 18 or even 21 feet or more, which may be advantageous in some situations, for example where the body of fluid that the liquid is being drawn from is dangerous, for instance having vegetation or weather situations that make a closer approach untenable. However, with increasing length of the extension, the pumping power will be reduced.

The system 6 includes a housing 14 for retaining the hose 12 in the retracted, or collapsed, state. As best shown in comparison of FIGS. 2 and 3, the hose is in the form of a collapsible conduit 12 that can be retracted to the housing 14. This provides an advantage when transporting the system attached to an aerial device, as it will reduce drag, increase functionality and increase safety during flight operations

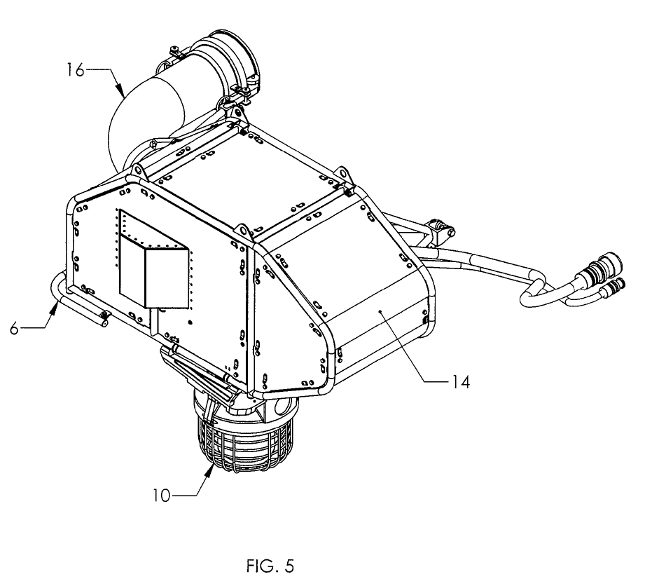

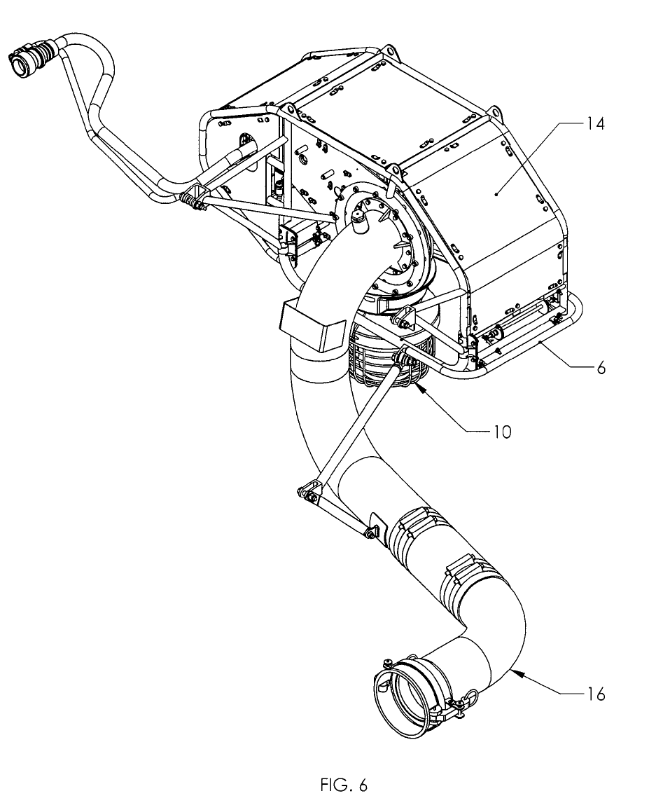

In FIGS. 5 and 6, the system 6 is shown with the housing 14 detached apart from the helicopter. A conduit 16 is used for directing the liquid into the holding tank which can be internal to or located beneath the helicopter 4, as well as directing the liquid from the holding tank for dispersal in fire fighting operations.

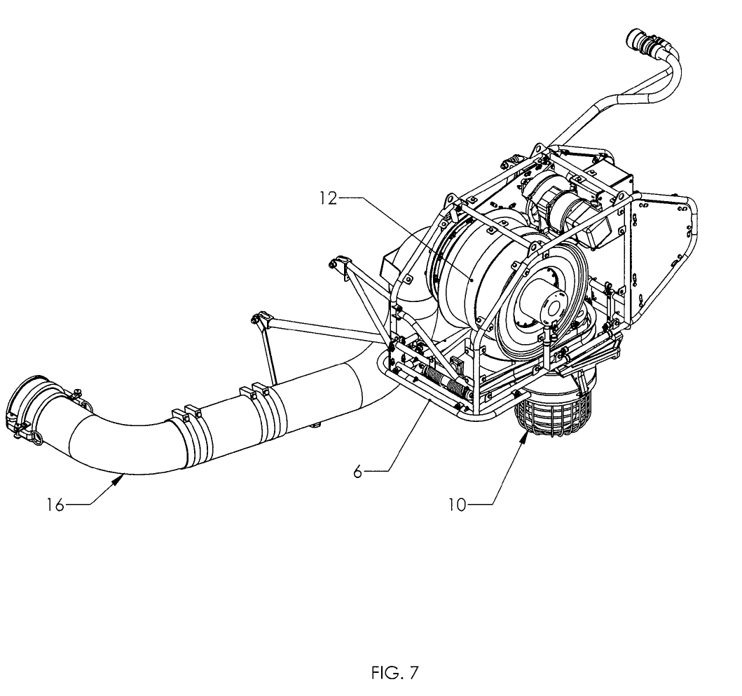

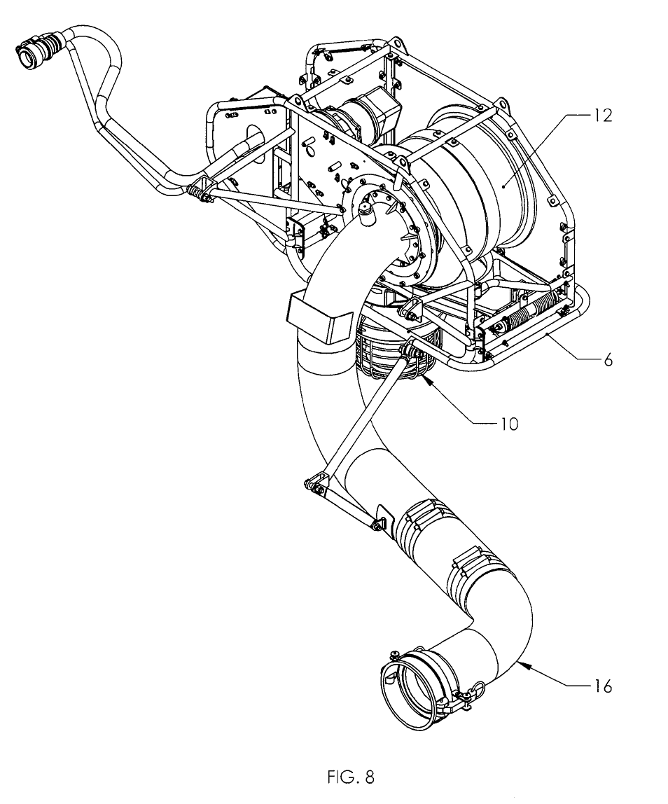

In FIGS. 7 and 8, the system 6 is shown with the housing removed, to exemplify one embodiment for extension of the collapsible conduit 12, in this case by providing a reel system moving the collapsible conduit 12 up or down.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A retractable pumping system for an aerial fire fighting unit adapted for drawing from a body of fluid to fill an onboard holding reservoir, the system comprising:
a pump;
a collapsible conduit;
a conduit in fluid communication between the retractable pumping system and an onboard holding reservoir; and
a housing for holding the collapsible conduit in a retracted position;
wherein said collapsible conduit can be extended at least about 15 feet from said housing.

2. The pumping system of claim 1 wherein said aerial fire fighting unit comprises a helicopter.

3. The pumping system of claim 1 wherein said onboard holding reservoir comprises a tank mounted to said aerial fire fighting unit.

4. The pumping system of claim 1 wherein said onboard holding reservoir comprises a tank located within said aerial fire fighting unit.

5. The pumping system of claim 1 further comprising means for securing said housing to aerial fire fighting unit.

6. The pumping system of claim 1 wherein said collapsible conduit extends up to approximately 18 feet.

7. The pumping system of claim 2 wherein said collapsible conduit extends at least about 21 feet.

8. The pumping system of claim 1 wherein said housing comprises a reel.

9. The pumping system of claim 7 wherein said reel is controlled mechanically.

10. The pumping system of claim 7 wherein said reel is controlled electronically.

11. A method of filling an onboard reservoir of an aerial fire fighting helicopter tanker with fluid, comprising the deployment of said pump system of claim 1 onto a helicopter.

12. The method of claim 11 wherein the onboard reservoir is on an EC 225 Super Puma.

13. The method of claim 11 wherein the onboard reservoir is located on an UH-60 Black Hawk.

14. The method of claim 11 wherein the onboard reservoir is on an EC 225 Super Puma.

15. The method of claim 11 including filling on onboard reservoir with up to, but not limited to, 1,000 gallons of fluid.

16. The method of claim 11 wherein said collapsible conduit extends up to approximately 18 feet.

17. The method of claim 11 wherein said collapsible conduit extends at least about 21 feet.

18. The method of claim 11 wherein said housing comprises a reel.

19. The method of claim 18 wherein said reel is controlled mechanically.

20. The method of claim 18 wherein said reel is controlled electronically.
